(19) United States
(12) Patent Application Publication
(10) Pub. No.: US 2008/0115334 A1
(43) Pub. Date: May 22, 2008

(54) Drawstring toggle

(75) Inventors: Chung Lung Chen, Taipei City (TW); Hsiao Hui Hsieh, Sinpu Township (TW); Shiu Shong Liao, Sindian City (TW)

Correspondence Address: RABIN & Berdo, PC, 1101 14TH STREET, NW, SUITE 500, WASHINGTON, DC, 20005, US

(73) Assignee: BUTTON INTERNATIONAL CO., LTD.

(21) Appl. No.: 11/600,898

(22) Filed: Nov. 17, 2006

(51) Int. Cl. F16G 11/10

(52) U.S. Cl. 24/115 G

(57) ABSTRACT

A drawstring toggle includes a male member being provided with an inward and downward extended retaining space, which has two opposite and outward projected lower stoppers with a plane top and an inclined bottom, and a side opening with an upward and inward extended lower edge to form a hook; a female member internally defining a receiving space for receiving the male member therein, and being provided with an open slot corresponding to the retaining space on the male member; and an elastic element being disposed in the receiving space to locate between an inner bottom of the female member and the male member. When the male member is depressed, the receiving space is horizontally aligned with the open slot on the female member, so that a drawstring may be sidewardly pushed into the aligned receiving space and open slot to enable easy replacement of a new drawstring toggle.

### FIELD OF THE INVENTION

The present invention relates to a drawstring toggle, and more particularly to an open type drawstring toggle that includes a male member provided with an open-side receiving space and a female member provided with an open slot corresponding to the receiving space, so that a drawstring may be easily sidewardly pushed into and accordingly connected to the drawstring toggle when the receiving space and the open slot are horizontally aligned with one another.

### BACKGROUND OF THE INVENTION

The drawstring toggle has been widely used on different products, including shoes, garments, knapsacks, and so on. The drawstring toggle may be differently design depending on an actual usage thereof. Generally, the drawstring toggle includes a male and a female member, on which through holes are correspondingly formed for an end of a drawstring to extend therethrough.

Please refer to FIGS. 1 and 2 that are exploded and assembled perspective views, respectively, of a conventional drawstring toggle. As shown, the conventional drawstring toggle includes a male member A, a female member B, and a spring C. The male member A is formed on a central column thereof with through holes A1, and on a bottom thereof with a first spring holder A2. The female member B is a hollow sleeve internally defining a receiving space B1 for receiving the male member A therein. The female member B is formed on a peripheral wall thereof with through holes B2 corresponding to the through holes A1 on the male member A, and on an inner bottom thereof with a second spring holder B3. The spring C is located between the male and the female member A, B with an end pressed against the first spring holder A2 and the other end against the second spring holder B3, such that the spring C normally pushes the male member A upward.

To use the above-described conventional drawstring toggle, first depress the male member A to horizontally align the through holes A1 with the through holes B2 on the female member B. And then sequentially extend a drawstring D through the female and the male member B, A. At this point, the drawstring D is in an adjustable state. When the depressed male member A is released, a restoring force of the spring C pushes the male member A upward to an elevated normal position, so that the through holes B2 and the through holes A1 are misaligned without locating at the same level. At this point, the drawstring D is bent and firmly locked between the misaligned male and female members A, B.

From the above description, it is understood the conventional drawstring toggle is a close type cord lock. That is, the drawstring D is locked in circumferentially closed holes on the drawstring toggle. For example, in producing a sports jacket or a knapsack, an end of the drawstring D is sewed to a tightness adjusting portion on the jacket or the knapsack, and the other end of the drawstring D is extended through the drawstring toggle before being sewed to the tightness adjusting portion. When the drawstring toggle is broken or damaged due to an exceeded temperature difference or a heavy collision with an external article, it is impossible to connect the drawstring to another close-type drawstring toggle that has circumferentially closed through holes. A user has to adjust the tightness adjusting portion by knotting the drawstring D at a desired point. Such knot adversely affects the overall beautiful appearance of the jacket or the knapsack.

Therefore, it is desirable to develop a drawstring toggle that provides the tightness adjusting function and allows convenient replacement thereof when necessary.

### SUMMARY OF THE INVENTION

A primary object of the present invention is to provide a drawstring toggle that is particularly suitable for adjusting an effective overall length of a drawstring extended therethrough and firmly holding the drawstring to the adjusted length, so as to adjust the tightness of a portion on a garment or a knapsack, for example, that is associated with the drawstring.

Another object of the present invention is to provide a drawstring toggle that allows easy and quick connection to a drawstring to replace a damaged or broken drawstring toggle.

To achieve the above and other objects, the drawstring toggle according to the present invention mainly includes a male member being provided on an axially extended central column thereof at a predetermined position with a retaining space having a side opening, such that the retaining space is inward and downward extended from the side opening into the central column; and the retaining space being provided on a bottom at two opposite ends with an outward projected stopper each; a female member internally defining a receiving space for receiving the male member therein, and being provided on a peripheral wall thereof with an open slot corresponding to the retaining space on the male member; and an elastic element being disposed in the receiving space of the female member to locate between an inner bottom of the female member and the male member.

Wherein the male member includes a first locating member located in the central column; and the female member includes a second locating member located on the inner bottom thereof.

In an embodiment of the present invention, the female member is provided on an upper rim with two opposite inclined guide ways corresponding to the two stoppers on the male member, and at two opposite inner edges on a plane bottom of the open slot with two recesses for receiving the stoppers of the male member therein.

In a preferred embodiment of the present invention, a lower edge of the side opening of the retaining space is upward and inward extended to form a hook.

In an ideal embodiment of the present invention, the elastic element is a spring.

When the male member is depressed, the retaining space is horizontally aligned with the open slot of the female member, so that a drawstring maybe conveniently connected to the drawstring toggle or a damaged drawstring toggle on the drawstring may be easily replaced simply by sidewardly pushing the drawstring into the aligned receiving space and open slot, and then releasing the male member.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional drawstring toggle;

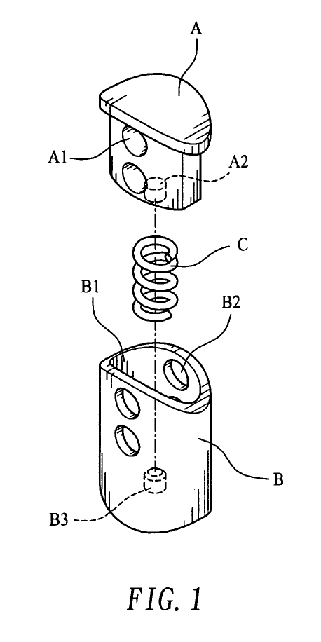

FIG. 2 is an assembled view of the drawstring toggle of FIG. 1 with a drawstring extended therethrough;

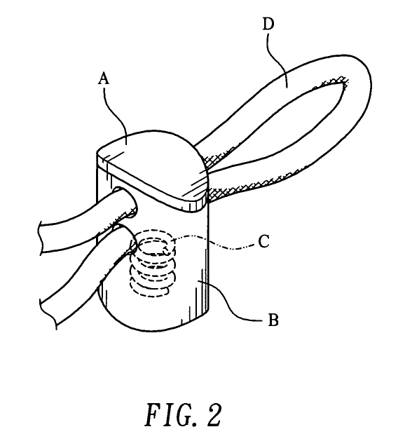

FIG. 3 is an assembled perspective view of a drawstring toggle according to a first embodiment of the present invention;

FIG. 4 is an exploded view of FIG. 3;

FIG. 5 is an assembled perspective view showing the drawstring toggle of FIG. 3 in use;

FIG. 6 is a vertical sectional view of the drawstring toggle of FIG. 3 with a male member thereof in a released position;

FIG. 7 is another vertical sectional view of the drawstring toggle of FIG. 3 with the male member thereof in a depressed position;

FIG. 8 is similar to FIG. 7 with the male member thereof in the released position;

FIG. 9 is an assembled perspective view of a drawstring toggle according to a second embodiment of the present invention;

FIG. 10 is an exploded view of FIG. 10;

FIG. 11 is an assembled perspective view showing the drawstring toggle of FIG. 3 in use;

FIG. 12 is a vertical sectional view of the drawstring toggle of FIG. 9 with a male member thereof in a released position;

FIG. 13 is another vertical sectional view of the drawstring toggle of FIG. 9 with a male member thereof in a depressed position; and

FIG. 14 is similar to FIG. 13 with the male member thereof in the released position.

### DETAILED DESCRIPTION OF THE PREFERRED EMBODIMENTS

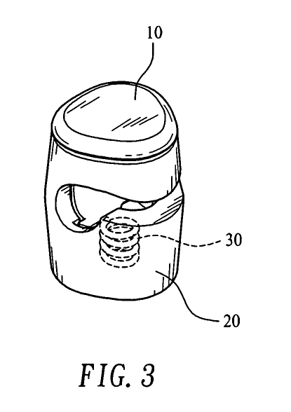

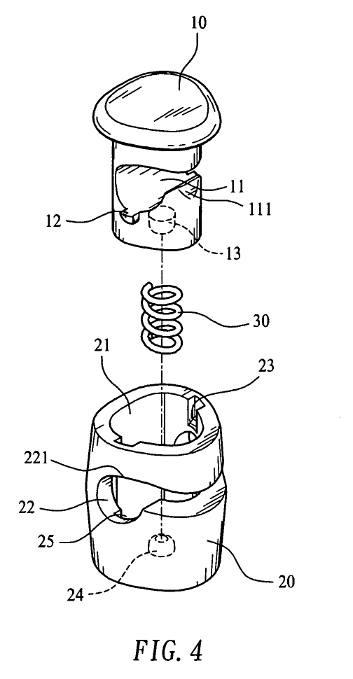

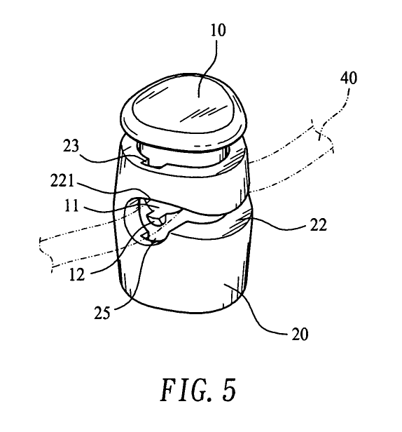

Please refer to FIGS. 3 through 6, in which a drawstring toggle according to a first embodiment of the present invention is shown. The drawstring toggle in the first embodiment mainly includes a male member 10, a female member 20, and an elastic element 30.

The male member 10 is provided on an axially extended central column thereof at a predetermined position with a retaining space 11 having a side opening, such that the retaining space 11 is inward and downward extended from the side opening into the central column. The retaining space 11 is provided on a plane bottom at two opposite ends with an outward projected stopper 12 each. The stopper 12 has a plane top and an inward inclined and curved bottom.

The female member 20 internally defines an axially extended receiving space 21 for receiving the male member 10 therein, and is provided with an open slot 22 corresponding to the retaining space 11 on the male member 10.

The elastic element 30 is disposed in the receiving space 21 to locate between an inner bottom of the female member 20 and a bottom of the central column of the male member 10.

The male member 10 includes a first locating member 13 located in a recess formed at the bottom of the central column of the male member 10; and the female member 20 includes a second locating member 24 located on the inner bottom thereof.

In an embodiment of the present invention, the female member 20 is provided on an upper rim with two opposite inclined guide ways 23 corresponding to the two stoppers 12 on the male member 10, and on two opposite inner edges of a plane bottom of the open slot 22 with two recesses 25 for receiving the stoppers 12 of the male member 10 therein.

In a preferred embodiment of the present invention, a lower edge of the side opening of the retaining space 11 is upward and inward extended to form a hook 111.

In an ideal embodiment of the present invention, the elastic element 30 is a spring.

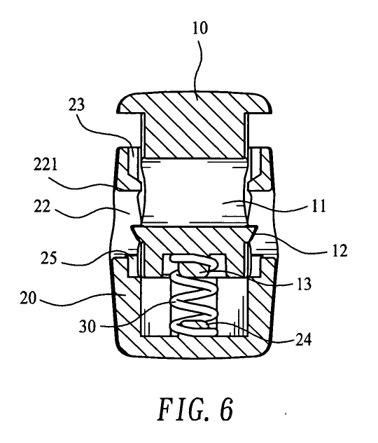

To assemble the drawstring toggle of the present invention, first position the elastic element 30 in the receiving space 21 of the female member 20, so that an end of the elastic element 30 is fixed to the second locating member 24 on the inner bottom of the female member 20. Then, align the two stoppers 12 on the male member 10 with the two inclined guide ways 23 on the top of the female member 20, and push the male member 10 down into the receiving space 21 of the female member 20. The inclined guide ways 23 on the top of the female member 20 allow the stoppers 12 of the male member 10 to easily slide into the receiving space 21, so that the male member 10 is received in the female member 20. At this point, the other end of the elastic element 30 is engaged with and held to the first locating member 13 at the bottom of the male member 10. When the male member 10 is fully downward pushed, the two stoppers 12 of the male member 10 are seated in the two recesses 25, and the retaining space 11 of the male member 10 and the open slot 22 of the female member 20 are horizontally aligned with one another to locate at the same level. At this point, a drawstring 40 may be easily extended through the drawstring toggle via the horizontally aligned open slot 22 and retaining space 11. Then, the male member 10 is released, and a restoring force of the elastic element 30 pushes the male member 10 upward to an initial position or the released position, so that the drawstring 40 is compressed and clamped between an upper edge 221 of the open slot 22 of the female member 20 and the bottom of the retaining space 11. It is noted when there is not a drawstring 40 extended through the retaining space 11 and the open slot 22, and the male member 10 is released and pushed upward by the elastic element 30, the two stoppers 12 of the male member 10 would abut against the upper edge 221 of the open slot 22 of the female member 20, as shown in FIG. 6, preventing the male member 10 from completely separating from the female member 20.

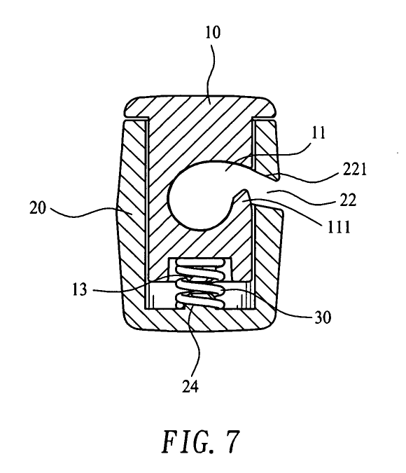

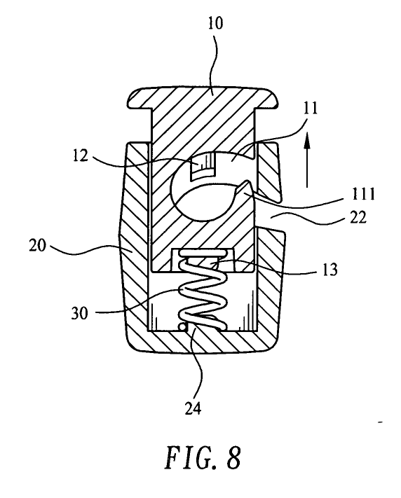

As can be seen from FIG. 7, the hook 111 upward extended from the lower edge of the side opening of the retaining space 11 is designed according to actual need to have a shape with a downward inclined inner upper surface that allows a drawstring 40 to easily slide into the retaining space 11. When the drawstring 40 is located in the retaining space 11, a slightly downward curved inner surface of the hook 111 is adapted to confine the drawstring 40 in the retaining space 11 behind the hook 111. When a push is released from the male member 10, a restoring force of the elastic element 30 pushes the male member 10 upward, so that the retaining space 11 of the male member 10 and the open slot 22 of the female member 20 are horizontally misaligned to compress and clamp the drawstring 40 between them. Meanwhile, the hook 111 of the retaining space 11 is moved upward along with the male member 10 to thereby seal a side portion of the open slot 22, as shown in FIG. 8, preventing the drawstring 40 from moving out of the female member 20 via the open slot 22 and ensuring the drawstring 40 to be firmly held in place by the drawstring toggle.

The drawstring toggle of the present invention may be used with a knapsack and/or a garment. For example, when a garment factory produce a garment, it might be necessary to extend a drawstring 40 through a tightness adjusting portion of the garment, such as a waist, to adjust the tightness thereof. To do so, a worker may prepare one drawstring toggle of the present invention, and depresses the male member 10 to horizontally align the retaining space 11 with the open slot 22 of the female member 20, so that a first end of the drawstring 40 may be easily extended through the drawstring toggle via the aligned retaining space 11 and open slot 22. Thereafter, the male member 10 is released and then pushed upward by a restoring force of the elastic element 30, so that the first end of the drawstring 40 is compressed and immovably clamped between the horizontally misaligned retaining space 11 and open slot 22. The other end of the drawstring 40 may be then sewed to another suitable point on the garment to complete the production of the tightness adjusting portion on the garment.

The drawstring toggle of the present invention allows a user to conveniently adjust an effective overall length of the drawstring, and accordingly, the tightness of a position provided with the drawstring toggle. In the event the drawstring toggle is damaged due to an external force, or broken due to an exceeded temperature difference, a user may conveniently replace the failed drawstring toggle with a new one simply by depressing the male member 10 of the new drawstring toggle and sidewardly pushing the drawstring 40 into the horizontally aligned retaining space 11 and the open slot 22.

Moreover, in the event a garment or a knapsack worker forgot to connect the drawstring toggle to the drawstring 40 before the two ends of the drawstring 40 are sewed to the garment or the knapsack, the worker needs not to pull out the whole drawstring 40 or remake the tightness adjusting portion. Instead, the worker needs only to push a length of the drawstring 40 exposed to outside into the drawstring toggle of the present invention via the aligned open slot 22 and retaining space 11.

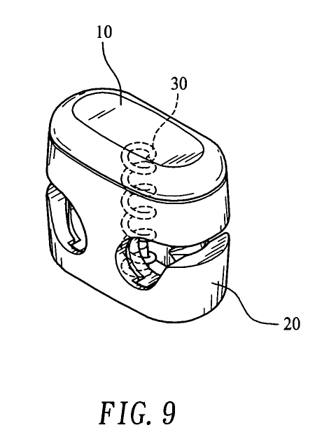

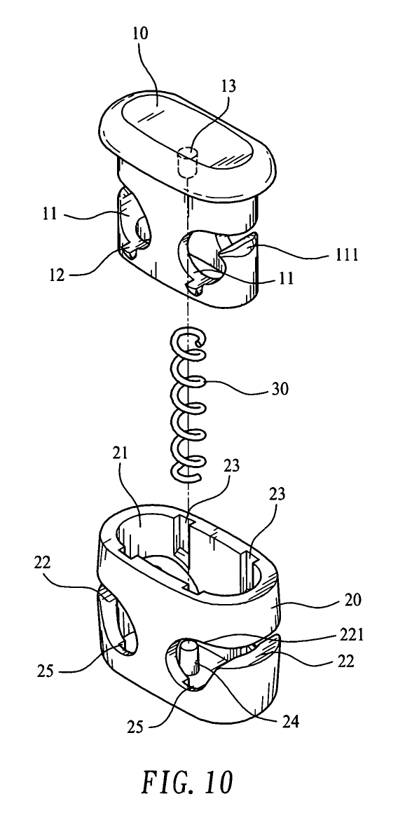

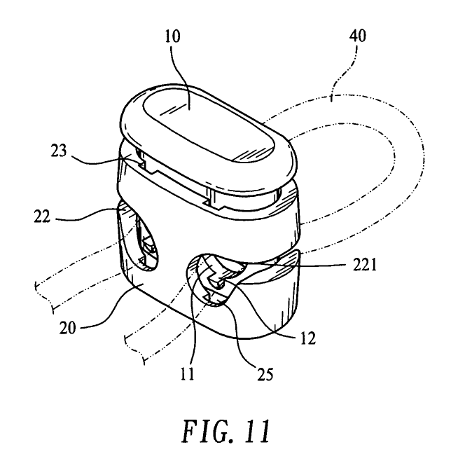

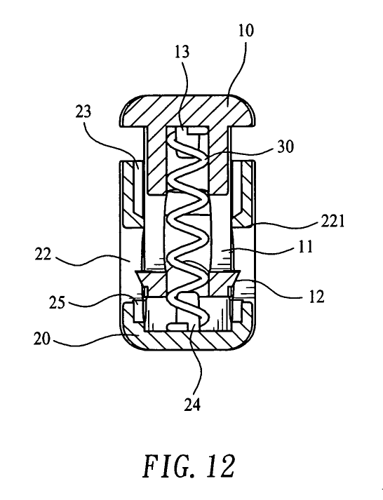

FIGS. 9 through 12 illustrate a drawstring toggle according to a second embodiment of the present invention. The second embodiment also includes a male member 10, a female member 20, and an elastic element 30. The male member 10 in the second embodiment has a hollow central column, on which two opposite retaining spaces 11 having a side opening each are symmetrically formed to inward and downward extend into the central column. Each of the retaining spaces 11 is provided on a plane bottom at two opposite ends with an outward projected stopper 12 each. Again, the stopper 12 has a plane top and an inward inclined and curved bottom.

The female member 20 in the second embodiment internally defines an axially extended receiving space 21 for receiving the male member 10 therein, and is provided with two opposite open slots 22 corresponding to the two retaining spaces 11 on the male member 10.

The elastic element 30 in the second embodiment is also disposed in the receiving space 21 of the female member 20 to locate between an inner bottom of the female member 20 and an inner top of the hollow central column of the male member 10.

In the second embodiment, the male member 10 includes a first locating member 13 downward projected from the inner top of the hollow central column; and the female member 20 includes a second locating member 24 located on the inner bottom thereof.

In an embodiment of the present invention, the female member 20 is provided on an upper rim with two pairs of opposite inclined guide ways 23 separately corresponding to the stoppers 12 on the two retaining spaces 11 on the male member 10, and on two opposite inner edges of a plane bottom of each open slot 22 with a recess 25 each for receiving the stoppers 12 of the male member 10 therein.

In a preferred embodiment of the present invention, a lower edge of the side opening of each retaining space 11 is upward extended to form a hook 111.

In an ideal embodiment of the present invention, the elastic element 30 is a spring.

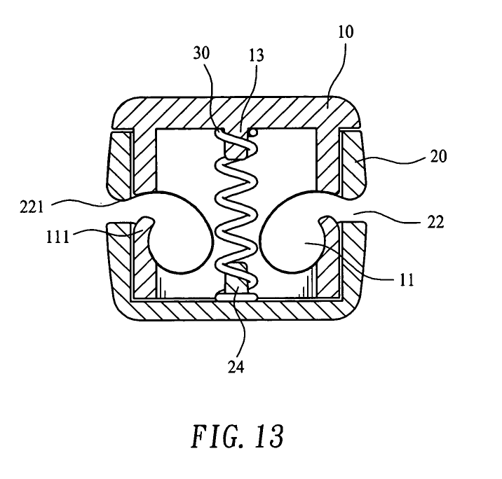

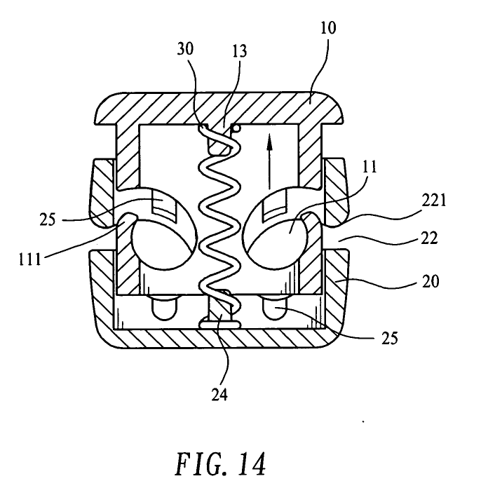

Please refer to FIGS. 13 and 14. In the second embodiment, when the male member 10 is depressed, the two retaining spaces 11 are horizontally aligned with the two open slots 22 on the female member 20, so that a drawstring 40 may be sequentially extended through or be sidewardly pushed into the drawstring toggle via the aligned receiving spaces and open slots. Again, with the side openings of the retaining spaces 11 and the open slots 22, a user may conveniently replace a damaged or broken drawstring toggle with a new one.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A drawstring toggle, comprising:
a male member being provided on an axially extended central column thereof at a predetermined position with a retaining space having a side opening, such that said retaining space is inward and downward extended from the side opening into said central column; and said retaining space being provided on a bottom at two opposite ends with an outward projected stopper each;
a female member internally defining a receiving space for receiving said male member therein, and being provided with an open slot corresponding to said retaining space on said male member; and
an elastic element being disposed in said receiving space of said female member to locate between an inner bottom of the female member and said male member.

2. The drawstring toggle as claimed in claim 1, wherein said side opening of said receiving space having a lower edge extended upward and inward to form a hook.

3. The drawstring toggle as claimed in claim 1, wherein said male member is provided in said central column at a predetermined position with a first locating member.

4. The drawstring toggle as claimed in claim 1, wherein said female member is provided on the inner bottom with a second locating member.

5. The drawstring toggle as claimed in claim 1, wherein said female member is provided on an upper rim with two opposite inclined guide ways corresponding to said two stoppers on said male member.

6. The drawstring toggle as claimed in claim 1, wherein said female member is provided on two opposite inner edges of a plane bottom of said open slot with a recess each for receiving said stoppers of said male member therein.
